(19) United States
(12) Patent Application Publication
(10) Pub. No.: US 2026/0087828 A1
(43) Pub. Date: Mar. 26, 2026

(54) SYSTEMS AND METHODS FOR COMPUTER RECOGNITION OF DIGITAL SPEED LIMIT SIGNS USING A VEHICLE ONBOARD CAMERA

(71) Applicant: Transportation Research Center, Inc., East Liberty, OH (US)

(72) Inventor: Minghao ZHU, East Liberty, OH (US)

(21) Appl. No.: 18/896,811

(22) Filed: Sep. 25, 2024

(51) Int. Cl. G06V 20/58; G01C 21/00; G06T 7/13; G06V 10/25; G06V 10/26; G06V 10/44; G06V 10/82

(52) U.S. Cl. CPC G06V 20/582; G01C 21/3815; G01C 21/3837; G06T 7/13; G06V 10/25; G06V 10/26; G06V 10/44; G06V 10/82; G06T 2207/20081; G06T 2207/20084; G06T 2207/20132; G06T 2207/30252

(57) ABSTRACT

The disclosure relates to a system for computer recognition of road signs using a camera aboard a vehicle having a camera capturing a plurality of image frames including a road sign, a computer having a sign detection module for identifying a region of interest from each of the image frames, said computer having a panel extraction module for extracting a portion of the region of interest having light emitting diodes from each of the image frames and outputting a plurality of processed image frames, said computer having a multi-frame processing module receiving the plurality of processed image frames as input and for averaging the pixel values of each of the processed image frames, and outputting an average image frame, and said computer having a classification model for determining a quantum of information displayed on the road sign.

### TECHNICAL FIELD

The present teachings relate to systems and methods for computer recognition of digital speed limit signs using a vehicle onboard camera. In one aspect, the present teachings relate to systems and methods for computer recognition of digital speed limit signs using a vehicle onboard camera when the information displayed on such signs is at least partially occluded, including by the flickering of light emitting diodes.

### BACKGROUND

In 2021, at least twenty-eight percent of fatal traffic incidents in the U.S. were speed-related. While some causes of speeding are driver-determined (e.g., intentional speeding such as racing or road-rage), others are caused by driver inattention, distraction, or neglect, such as missing speed limit changes because of driver distraction, occlusion of speed limit signs by other traffic participants or weather conditions, and driver inattention to current vehicle speed.

Intelligent speed assistance technologies (“ISAs”) have been developed that promote speed-related safety and have been shown to be effective in reducing inappropriate speeds and improving road safety. Passive ISA systems display the speed limit for the current road and may optionally alert drivers with visible or audible notifications when they exceed the posted limits. Active ISA systems may limit vehicle speeds to appropriate speeds such as posted speed limits.

However, reliable information is required to implement ISAs. Common data sources include digital maps working with global navigation satellite systems. However, digital maps and navigation systems must be kept up-to-date and may not have information regarding temporary speed limit changes, such as in the case of construction zones. Digital maps also may be cumbersome for the vehicle operator to update their digital maps frequently and impossible to guarantee full distribution of sufficient digital map updates required to reflect all temporary speed limit changes. Additional data sources like vehicle-to-infrastructure or vehicle-to-everything communication can also be used to provide or communicate speed limits but require vehicles to have dedicated hardware to enable such communications that may not be available in all vehicles or at all infrastructure locations.

Traffic sign recognition may also be used to provide speed limit information to implement ISAs. However, they may be unreliable when traffic signs are obscured for short periods or when LED or other electronic displays are used on temporary traffic signs.

Pulse-width modulation is a technology commonly used to modulate the effective power delivered to devices like LEDs by rapidly switching them on and off. The percentage of time that the pulse-width modulation signal remains high in a cycle is called the duty cycle. Because of its energy efficiency and brightness control advantages, pulse-width modulation is common for LED applications, including digital speed limit signs. Multiplexing is another technique commonly used in matrix LED sign application to achieve simpler electronics designs. It divides the display into multiple sections, often each of these sections represent one or a few rows or columns, and only drives the LEDs of one section at a time.

Pulse-width modulation and multiplexing cause a problem often referred to as LED flickering. LED flickering is a phenomenon where LEDs appear to flash or flicker rapidly. Human vision does not perceive these effects so long as the frequency is sufficiently high, but the performance of camera-based perception systems often suffers from LED flickering. Similar to pulse-width modulation, a camera captures frames by periodically opening either a physical or electronic shutter to allow lights to reach or effect the imaging sensor. The period that the shutter opens per frame is called exposure time. If the exposure period does match the time that an LED is “ON,” the camera will not capture that the LED is “ON” in any image taken during that exposure period.

The deployment of advanced driver assistance systems and automated driving systems, means that roads are utilized by both human-driven and computer-driven vehicles, compounds the importance of this computer-vision problem. When computer-driven vehicles use features like lane departure warning and traffic and advanced driver assistance or automated driving systems, they rely on lane marks and traffic signs, respectively. Such infrastructure was designed for humans, not machines. While permanent speed limits posted on signs can usually be obtained from digital maps, temporary speed limits posted on signs require camera-based perception. Camera-based perception is poor when the image frames captured do not include all information displayed to a human on a sign, such as when digital signs utilize LEDs that flicker at the time when the digital sign is captured by a camera or other device for image capture or recognition.

The present application relates to systems and methods to detect (including to localize+classify) digital traffic signs, and in particular, digital speed limit signs, using machine vision. Because of LED flickering and multiplexing, using machine vision to detect digital signs is challenging. Existing approaches include using specialized image sensors and capturing the same sign multiple times at the same position. Using specialized image sensors incurs additional cost, makes this assistive driving technology (including sign detection) unavailable to previous generations of vehicles without specialized sensors or other specialized equipment, and is hard to update (often even requiring new hardware). In addition, multi-capturing while staying stationary makes it unusable or unreliable in any driving situation (e.g., urban and highway).

In summary, there is a need to develop solutions that address and overcome above-mentioned problems in the art.

### SUMMARY

The following is a summary providing an initial understanding of the teachings herein. The summary does not necessarily identify each and every key element nor is it intended to limit the scope of the teachings, but merely serves as an introduction to the following description.

The systems and methods described herein relate to systems and methods to detect (e.g., localize+classify) digital traffic signs and, in particular, digital speed limit signs using machine vision. The systems and methods require no specialized hardware and work when the system is in motion, or the method is practiced, even up to highway speeds. Apart from handling LED flickering and other forms of occlusion, sign detection uses data-driven methods that may rely on a large high-quality training dataset. Given the fact that digital traffic signs are not widely used on public roads, collecting sufficient training data is time-consuming and labor-intensive (e.g., traveling long distances to different places to collect data that often does not remain constant). Therefore, the systems and methods described herein may be designed to take an entire image as an input or may first localize the LED panel and use that as an input. Accordingly, training data may not need to consider variance in background.

LED panels with different contents can be created artificially. Difference variances can be added to created LED panels like viewing angle, brightness, and imperfection of multi-capture augmentation to form a training dataset. Then the artificial training dataset can be used for training a classification model that is robust to variances. Above all, the proposed systems and methods handle LED flickering at speeds up to highway speed without specialized hardware.

The systems and methods may have two components: generating inference input and training classification model. Inference input is generated using a series of preprocessing steps including localizing the LED panel and reconstructing LED panel content with multi-capture. For the training classification model, artificial LED panels are created based on the understanding of the actual signs to be classified. Then variances are added to LED panels which form the training dataset. Finally, supervised learning is used to get a classification model.

Existing research on road sign detection focuses on permanent signs instead of digital signs, and in particular permanent speed limit signs instead of digital speed limit signs. The development of detection methods begins with classical image processing techniques, including color segmentation, shape detection, and optical character recognition (OCR). With the significant development of machine learning, especially deep learning, data-driven methods have proven successful in many applications, including object detection and classification in the transportation domain. Many popular traffic sign datasets, including LISA-TS, GTSDB, and TT-100k for signs in the United States, Germany, and China, respectively, have been developed and used for model training and benchmarking. However, none cover digital speed limit signs. Existing speed limit detection methods commonly use a single frame for detection. Some include a tracking stage to ensure each speed limit is only detected and alerted once. In a series of consecutive frames captured by a camera when passing a speed limit sign, the sign can be occluded by other traffic participants in the middle frames but un-occluded at the beginning and the end. This can cause multiple detections of the same sign. Alerting on multiple detections can generate overwhelming information and distract drivers. No known method uses multiple frames to enhance digital speed limit detection.

In one aspect, the present application relates to a system for computer recognition of speed limit signs using a camera aboard a vehicle. The system includes a camera capturing a plurality of image frames including a speed limit sign, the speed limit sign having light emitting diodes that flicker at a rate unequal to the capture rate of the camera. The system includes a computer that is in data communication with said camera, the computer having a sign detection module for identifying a region of interest from each of the image frames. The sign detection module has a deep neural network detection module for determining a bounding box of the region of interest, the deep neural network detection module trained on images of speed limit signs and an optical character recognition and processing module for determining whether the region of interest is a false positive. The computer has a panel extraction module for extracting a portion of the region of interest with light emitting diodes from each of the image frames and outputting a plurality of processed image frames. The panel extraction module has a segment anything module, receiving the bounding box as input, for generating a binary mask relating to the digital speed limit sign in the image frame. The panel extraction module also an edge detection module, receiving the binary mask as input, for detecting the edges of the digital speed limit sign in the image frame and outputting the detected edges. The panel extraction module has an inverse perspective mapping module for projecting the region of the image frame within the detected edges onto an image plane to output a projected image frame. The panel extraction module has a cropping module for cropping the projected image frame based on the binary mask to produce a cropped image frame. The panel extraction module also has an equalization and binarization module inputting the cropped image frame and setting each pixel in the cropped image to either be at a first value or a second value and outputting a processed image frame. The computer has a multi-frame processing module receiving the plurality of processed image frames as input and for averaging the pixel values of each of the processed image frame and outputting an average image frame. The computer also has a deep neural network classification model for determining a speed limit displayed on the speed limit sign.

In one aspect, the edges may define a shape selected from at least: a circle, a triangle, a square, a quadrilateral, a hexagon, an octagon, a pentagon, a crossbuck, a crest, or a shield.

In one aspect, the computer further has a training module for training the classification model based on the determined speed limit.

In one aspect, the computer further has a testing module for evaluating the trained classification module.

In one aspect, the speed limit is indicated in the vehicle.

In one aspect, the speed limit is used in connection with the operation of the vehicle.

In one aspect, the computer distributes execution of the panel extraction module for different image frames to other computers in other vehicles and collects processed image frames from the other computers for execution of the multi-frame processing module and classification module on the computer.

In one aspect, speed limit and information regarding the location of the speed limit sign are sent to a digital map server for updating a digital map.

In one aspect, the present application relates to a system for computer recognition of road signs using a camera aboard a vehicle. The system includes a camera capturing a plurality of image frames including a road sign. The system also includes a computer in data communication with said camera, said computer having a sign detection module for identifying a region of interest from each of the image frames. The sign detection module has a detection module for determining a bounding box of the region of interest. The computer has a panel extraction module for extracting a portion of the region of interest having light emitting diodes from each of the image frames and outputting a plurality of processed image frames. The panel extraction module has a segment anything module, receiving the bounding box as input, for generating a binary mask relating to the road sign in the image frame. The panel extraction module also has an edge detection module, receiving the binary mask as input, for detecting the edges of the road sign in the image frame and outputting the detected edges. The panel extraction module also has an inverse perspective mapping module for projecting the region of interest onto an image plane based on the detected edges to produce a projected image frame. The panel extraction module also has a cropping module for cropping the projected image frame based on the binary mask to produce a cropped image frame. The panel extraction module also has an equalization module inputting the cropped image frame and setting at least a subset of the pixels to a first value and outputting a processed image frame. The computer has a multi-frame processing module receiving the plurality of processed image frames as input and for averaging the pixel values of each of the processed image frames and outputting an average image frame. The computer has a classification model for determining a quantum of information displayed on the road sign.

In one aspect, the detection module is a deep neural network trained on images of road signs.

In one aspect, the road sign is a speed limit sign and the quantum of information is a speed limit.

In one aspect, the speed limit is indicated in the vehicle.

In one aspect, the speed limit is used in connection with the operation of the vehicle.

In one aspect, the quantum of information is transmitted to a database.

In one aspect, the quantum of information is transmitted to a database for recall.

In one aspect, the edges define a shape selected from at least: a circle, a triangle, a square, a quadrilateral, a hexagon, an octagon, a pentagon, a crossbuck, a crest, or a shield.

In one aspect, the classification model is a deep neural network and the computer further has a training module for training the classification model based on the determined quantum of information.

In one aspect, the computer further has a testing module for evaluating the trained classification module.

In one aspect, the computer distributes execution of the panel extraction module for different image frames to other computers in other vehicles and collects processed image frames from the other computers for execution of the multi-frame processing module and classification module on the computer.

In one aspect, the speed limit and information regarding the location of the speed limit sign are sent to a digital map server.

In one aspect, the speed limit and information regarding the location of the speed limit sign are sent to a digital map server for updating a digital map.

In one aspect, a method for computer recognition of road signs using a camera aboard a vehicle, having the steps of providing a camera capturing a plurality of image frames including a road sign and providing a computer in data communication with said camera. The method includes the step of executing a sign detection module on said computer for identifying a region of interest from each of the image frames, including executing a detection module for determining a bounding box of the region of interest. The method includes the step of executing a panel extraction module for extracting a portion of the region of interest having light emitting diodes from each of the image frames and outputting a plurality of processed image frames. The step of executing the panel extraction module also includes the step of executing a segment anything module by receiving the bounding box as input and generating a binary mask relating to the road sign in the image frame. The step of executing the panel extraction module also includes the step of executing an edge detection module by receiving the binary mask as input and detecting the edges of the road sign in the image frame and outputting the detected edges. The step of executing the panel extraction module also includes the step of executing an inverse perspective mapping module for projecting the region of interest onto an image plane based on the edges to produce a projected image frame. The step of executing the panel extraction module also includes the step of executing a cropping module for cropping the projected image frame based on the binary mask to produce a cropped image frame. The step of executing the panel extraction module also includes the step of executing an equalization module inputting the cropped image frame and setting at least a subset of the pixels to a first value and outputting a processed image frame. The method also includes the step of executing a multi-frame processing module on said computer by receiving the plurality of processed image frames as input and averaging the pixel values of each of the processed image frames, and outputting an average image frame. The method also includes the step of executing a classification model for determining a quantum of information displayed on the road sign.

In one aspect, the road sign is a digital speed limit sign having light emitting diodes that flicker at a rate unequal to the capture rate of the camera, and the step of executing the sign detection module further comprising the step of executing an optical character recognition and processing module for determining whether the region of interest is a false positive, and wherein the detection module is a deep neural network detection module trained on images of speed limit signs, and the quantum of information is a speed limit displayed on the digital speed limit sign.

These additional, and/or other aspects and/or advantages of the present disclosure are set forth in the detailed description which follows; possibly inferable from the detailed description; and or learnable by practice of the present disclosure.

Other features and aspects of the present teachings will become apparent from the following detailed description, taken in conjunction with the accompanying drawings, which illustrate by way of example the features in accordance with embodiments of the present teachings. The summary is not intended to limit the scope of the present teachings.

### BRIEF DESCRIPTION OF THE DRAWINGS

FIG. 1 is a schematic diagram of a systems and method for computer recognition of road signs using a vehicle onboard camera.

FIG. 2A shows a timing diagram comparing the timing of a camera taking an exposure with the timing of an LED being on/off.

FIG. 2B shows a timing diagram of a multiplexed LED system with three different LEDs (R, G, and B) and compares the timing of a camera taking an exposure with the timing of each LED being on/off.

FIG. 3A shows an electronic speed limit sign displaying a speed limit of 50 miles per hour as it would appear to the human eye.

FIGS. 3B-3E show the electronic speed limit sign of FIG. 3A as it may be captured by a digital camera at different points in time.

FIG. 4 shows a schematic diagram for utilizing the output of the systems and method for computer recognition of road signs of FIG. 1. using multiple vehicles with different capabilities.

FIG. 5 shows a schematic diagram for utilizing the output of the systems and method for computer recognition of road signs of FIG. 1 using to update digital map servers.

### DETAILED DESCRIPTION OF THE DRAWINGS

The present teachings are described more fully hereinafter with reference to the accompanying drawings, which are part of this description, and in which the present embodiments are shown. The following description is presented for illustrative purposes only and the present teachings should not be limited to these embodiments.

In the following description, various aspects of the present disclosure are described. For purposes of explanation, specific configurations and details are set forth in order to provide a thorough understanding of the present disclosure. However, it will also be apparent to one skilled in the art that the present disclosure may be practiced without the specific details presented herein. Furthermore, well known features may have been omitted or simplified in order not to obscure the present disclosure. With specific reference to the drawings, it is stressed that the particulars shown are by way of example for purposes of illustrative discussion of the present disclosure only and are presented to show what is believed to be most useful and readily understood description of the principles and conceptual aspects of the disclosure. In this regard, no attempt is made to show structural details of the disclosure in more detail than is necessary for a fundamental understanding, the description taken with the drawings making apparent to those skilled in the art how the several forms of the disclosure may be embodied in practice.

Before the disclosure is explained in detail, it is to be understood that the disclosure is no limited in its application to the details of construction and the arrangement of the components set forth in the following description or illustrated in the drawings. The disclosure is applicable to other disclosure that may be practiced or carried out in various ways as well as to combinations thereof. Also, it is to be understood that the phraseology and terminology employed herein are for the purpose of description and should not be regarded as limiting.

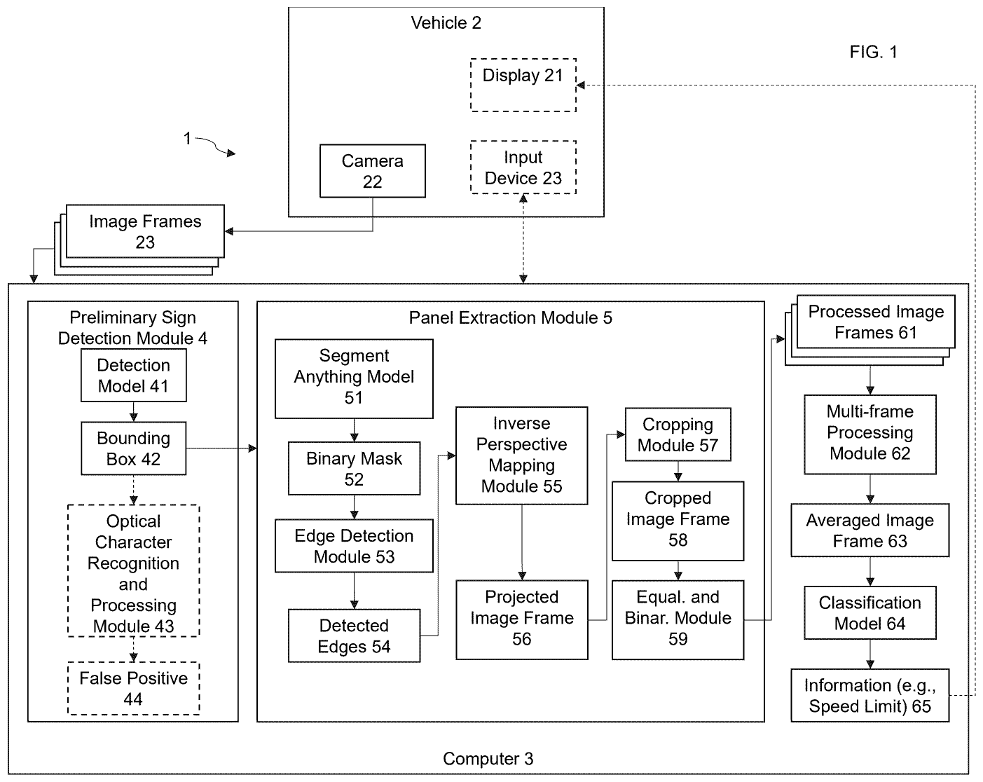

FIG. 1 shows a diagram of a system 1 for computer recognition of digital speed limit signs using a vehicle onboard camera. The system 1 includes a vehicle 2. Vehicle 2 may be any kind of vehicle, including but not limited to a car, truck, SUV, motorcycle, or other road-going vehicle.

Vehicle 2 may have a display 21. Display 21 may be a screen or other known system for displaying information to a driver. Display 21 may be on the vehicle 2's dashboard, center console, rear-view mirror, side-view mirror, or be projected or otherwise displayed on the windshield. One of the purposes of display 21 may be to display information to a driver 21, including information relating to road conditions or regulations, including speed limits. Alternatively or in addition, display 21 may not be a visual display, but an audio display. In such scenarios, display 21 may include a speaker or other noise-generating device.

Vehicle 2 may have a camera 22. The camera 22 may be any type of camera capable of taking still or video images. Camera 22 may be specifically adapted for use in ISA systems, or be a standard consumer camera or webcam. Camera 22 may take a series of image frames 23. The image frames 23 may be separated in time by a known period.

Vehicle 2 may also have an input device 23. Input device 23 may be any known input device to a vehicle 2, including a button, knob, switch, trackpad, or touch screen. If input device 23 is a touch screen, it may be integrated into the display 21.

The system 1 may have a computer 3. Computer 3 may be or include a processor, remote computer, computer server, network, or any other computing resource, including mobile devices. In some embodiments, computer 3 may be onboard vehicle 2.

Computer 3 may be in data communication with display 21. For example, the computer 3 may provide any information 65 for display in the vehicle 2.

Computer 3 may be in data communication with the camera 22. For example, camera 22 may provide image frames 23 to the computer 3. Computer 3 may also control actuation of the camera 22, such as to take new image frames 23 or to switch modes or settings on the camera 22.

Computer 3 may be in data communication with input device 23. Input device 23 may send command or control signals to the computer 3, including those relevant to the operation of the system 1.

Computer 3 may have a preliminary sign detection module 4 that receives image frames 23 from the camera 22. The preliminary sign detection module 4 may have detection model 41.

Detection model 41 may receive image frames 23 as input and output a bounding box 42 that identifies a region of interest in each image frame 23. The detection model 41 may be a deep neural network. The detection model 41 may be trained a variety of images to detect road signs, such as speed limit signs. As an example in the case of speed limit signs, the variety of images used for training the detection model 41 may include images with regular speed limit signs, images with variable speed limit signs, and images with no speed limit signs (i.e., negative samples). However, it is understood that the detection model 41 may be trained to detect any type of sign with any information.

An example detection model 41 may be trained from a pre-trained Swin Transformer backbone such as swin_small_patch4_window7_224. In such an example, detection model 41 may be trained using MMDetection on 334 labeled images collected on highways in the US, including three types of data: regular speed limit signs, variable speed limit signs, and no speed limit signs (negative samples).

In some embodiments, the preliminary sign detection module 4 may include an optical character recognition and processing module 43 for filtering false positives 44. Optical character recognition may be run in the region of interest bounded by the bounding box 42 to determine if the region of interest includes a road sign of the desired type for the application. As an example, optical character and processing module 43 may run EasyOCR for optical character recognition. In the example of speed limit signs, after optical character recognition is run, word differences may be calculated based on “speed” and “limit” and the optical character recognition results. The word difference calculation may include length differences and/or letter distribution differences. To account for potential occlusion, the length check may pass if the length difference is less than a predetermined value such as two (2). The letter distribution check may be passed if a predetermined percentage of letters (e.g., 80%) in the recognition results match the ground truth (in the case of our example, “speed” and “limit”). The optical character recognition and processing module 43 may declare a potential image frame 23 a false positive if one or both of these word differences fail.

The computer 3 may have a panel extraction module 5 for extracting the portion of the road sign that contains the desired information, such as the speed limit in the case of speed limit signs. Panel extraction module 5 may receive the bounding box 42 and the image frames 23 as input and may output processed image frames 61. Processed image frames 61 may be sections of the road sign that include the desired information, such as speed limits. As explained below, panel extraction module 5 may include a series of processing models and modules that perform operations on the image frames 23 and bounding box 42.

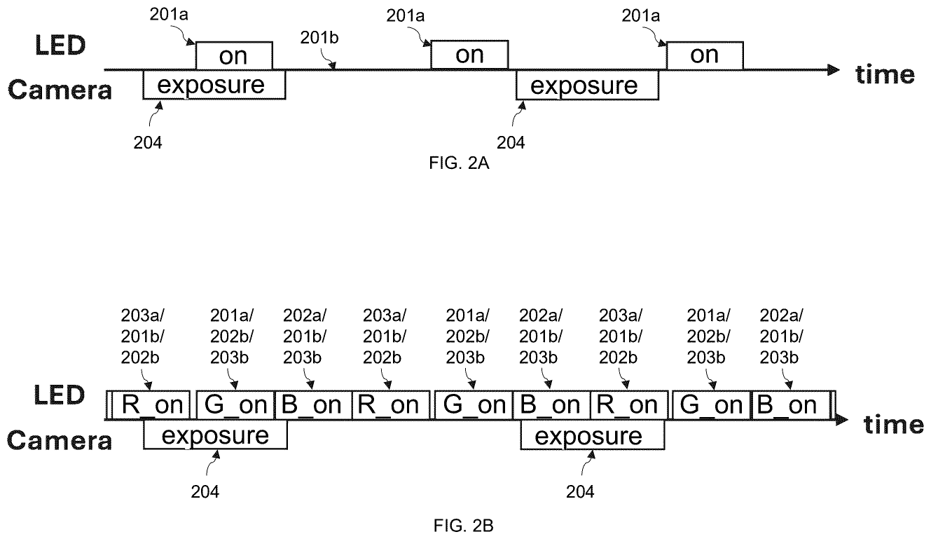

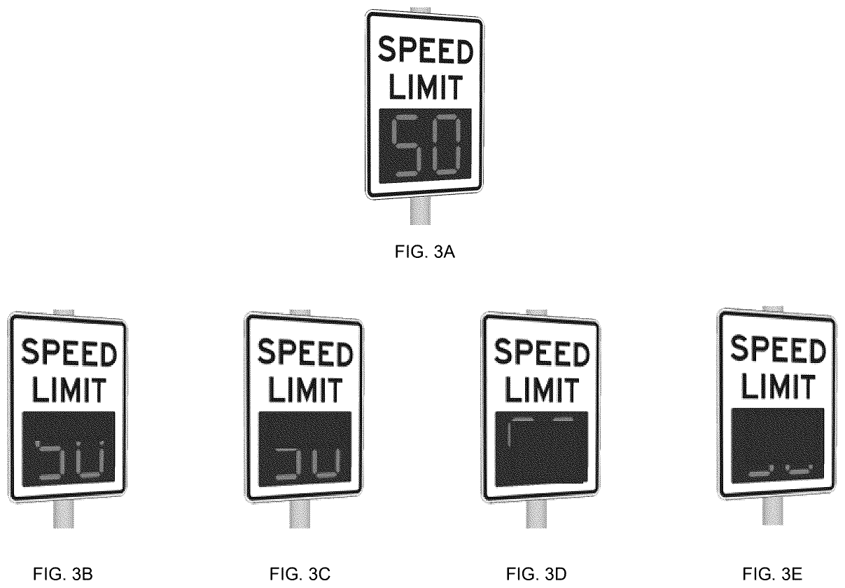

Panel extraction may be difficult because each image frame 23 is not guaranteed to contain complete information. For example, image frames 23 containing the road signs may have the road signs partially obscured. In the case of electronic road signs that use LEDs or other types of illuminated information that flickers, the camera is not guaranteed to capture all the LEDs as they are illuminated, as shown in FIGS. 2A and 2B. For example, FIG. 2A shows that LED flickering may not correlate to the capture period of the LED camera. FIG. 2B shows that when LED multiplexing is used in the road sign (in the case of this sign, split between red, blue, and greed LEDs), while some LEDs may always be captured, not all will be on during the LED camera's exposure. Both of these situations can lead to partial-capture of the information displayed on the LED road sign, such as in the examples shown in FIGS. 3A-E3. However, by overlaying multiple panels of multiple frames, the combined frames may contain a complete speed limit, or at least a speed limit that is more recognizable.

In addition, as the vehicle moves, the size of the sign projected onto the image plane and the angle between the sign plane and the image plane changes. Moreover, because bounding box 42 is preferably a rectangle (in the case of a speed limit sign), it may not match the actual shape of the road sign, which may be a quadrilateral because of viewing angle and camera distortion. Similar distortions occur on other types of signs and would be understood to a person having ordinary skill in the art, as road signs may be a circle, a triangle, a square, a quadrilateral, a hexagon, an octagon, a pentagon, a crossbuck, a crest, a shield, or other known shapes.

Accordingly, it is preferable that panel extraction module 5 may have a segment anything model 51 that receives the bounding box 42 and image frames 23 as input and outputs a binary mask 52. While other segmentation algorithms may be used, the segment anything model 51 may use zero-shot generalization to enable it to segment objects in images that are not covered in its training data. Binary mask 52 may be a binary representation of where the road sign appears in the bounding box 42. An example segment anything model is SAM from Meta AI, released in April 2023, and may be (checkpoint sam vit 1 0b3195.pth).

Other algorithms or processes for segmentation may also be used, and may result in similar binary masks or run-length encoding (RLE) instead of simple geometry shapes like rectangles. Alternatively, if computational resources are scarce, or if simply desired, a detection algorithm may be used, since they require far less data labeling effort increases.

The binary mask 52 may be input to an edge detection module 53 of the panel extraction module 5. The edge detection module may use the binary mask to determine boundaries or edges 54 of the road sign. The image frames 23 may also be used. The edge detection module 53 may output the detected edges 54.

In the case of a speed limit sign like that shown in FIG. 3A, there may be four edges determined. In this example, the assumption can be made that the sign is rectangular, has a fixed aspect ratio, and is nearly vertical. Edge detection module 53 may use the region of the image near the bounding box with some extra margin and performing edge detection in four directions: top-to-bottom, right-to-left, bottom-to-top, and left-to-right for top, right, bottom, and left boundaries. Each boundary may be a straight line fit through the detected edge pixel locations these conditions being within tolerance to qualify each line bounding the mask. Once the lines are obtained the intersection of each adjacent pair gives the detected edge 54 coordinates. A person having ordinary skill in the art would understand that other road signs may have other shapes, and therefore other boundaries/edges and would know how to adjust the edge detection module appropriately.

Panel extraction module 5 may have an inverse perspective mapping module 55 that receives the detected edges 54 and the image frames 23 as input. The inverse perspective mapping module 55 uses the detected edges 54 to project the image frames 23 onto an image plane and outputs a projected image frame 56.

Panel extraction module 5 may have a cropping module 57 that receives the projected image frame 56 as input. The cropping module 57 crops the projected image frame 56 to only include the portions of the road sign with the desired information. For example, in the case of a speed limit sign, the cropping module 57 may know the ratio and location of the part of the sign that contains the speed limit and crop the projected image frame 56 to just keep that portion as a cropped image frame 58. The cropping module 57 may also use optical character recognition to determine a sign type of the road sign in the projected image frame 56 and apply a similar method to keep only the relevant portion as a cropped image frame 58. If the cropping module 57 cannot determine a road sign type, or if it would be preferred to keep all information for later processing, the cropping module 57 may not crop the image, but pass along the projected image frame 56 as the cropped image frame 58.

An equalization and binarization module 59 of the panel extraction module 5 may then receive the cropped image frame 58. The equalization and binarization module 59 may perform Histogram equalization and binarization on the cropped image frame 58. In the example of a speed limit sign with LEDs, the cropped image frame 58 may have regions of “ON” LEDs that are white and the regions of “OFF” LEDs that are black. This can be seen in the image frames shown in FIGS. 3B-E. Histogram equalization is used to adapt the method to different light conditions, so that “ON” LEDs are always the brightest, and “OFF” LEDs are the darkest in the cropped image frame 58, with some additional brightness values in the middle (likely due to reflections). Binarization then occurs, so that the pixels containing “ON” and “OFF” LEDs are the only ones kept at two distinct values, resulting in processed image frames 61. For example, the “ON” and “OFF” LEDs may be set to maximum and minimum values, respectively. Equalizing and binarizing the cropped image frames 58 allows them to be processed together easier. The processed image frames 61 are output.

Image frames 23 may be processed by the preliminary sign detection module 4 and the panel extraction module 5 sequentially or in parallel. Once each of image frames 23 are converted to processed image frames 61, they may be input to a multi-frame processing module 62 of the computer 3. The multi-frame processing module 62 averages each of the processed image frames 61 to create an averaged image frame 63.

The averaged image frame 63 is input to a classification model 64. The classification model 64 may be a deep neural network classification model. The classification model 64 may be used to obtain the information 65 in the averaged image frame 63. For example, the classification model 64 may obtain the speed limit 65 from the averaged image frame 63. The classification model may be based on a pre-trained Swin Transformer model, provided in MMPretain.

Before used as part of the system 1, the classification model 64 may be trained. The classification model 64 may be trained on actual images of road signs, or on artificially created images of road signs, that may have artificially induced variations, such as in the information displayed, viewing angle, brightness, and imperfection. Images may be divided into training, validation and testing sets. For example, they could be divided into 70% training, 10% validation, and 20% testing. After training, the classification model 64 may be evaluated using the testing frames.

The information 65, such as the speed limit, may be displayed on the display 21 of the vehicle 2. The type of information 65 and its relation to the current vehicle condition may determine how the information 65 is displayed. For example, a speed limit may be displayed optically for so that a driver may see it, however, if the driver is exceeding the speed limit, a sound may also be played. A person having ordinary skill in the art would understand how to display the information 65 on the display 21.

The system 1 may run in real-time, or near-real time, to provide up-to-date information to the vehicle 2.

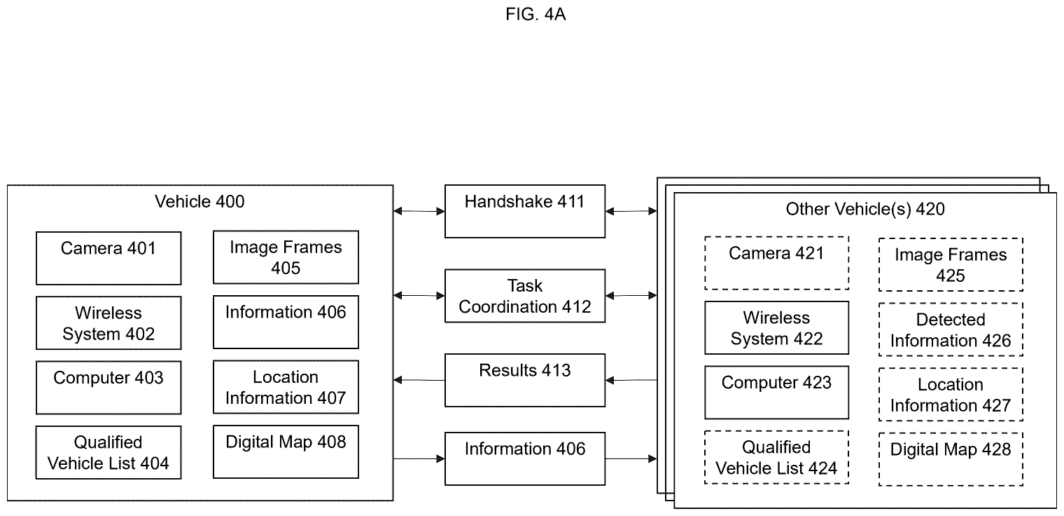

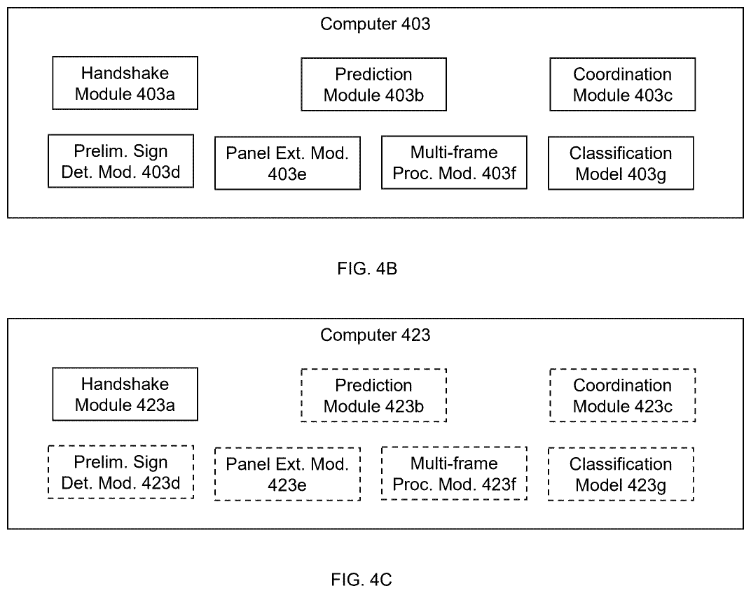

FIG. 4A shows a vehicle-to-vehicle information exchange system using the output of the system and method disclosed in FIG. 1 and discussed above. Vehicle 400 may have the capabilities of vehicle 2, including in having a camera 401, a computer 403. Computer 403 may have a handshake module 403a, a prediction module 403b, a coordination module 403c, a preliminary sign detection module 403d, a panel extraction module 403e, a multi-frame processor module 403f, and a classification module 403g, as shown in FIG. 4B.

Vehicle 400 may also have a wireless system 402 to communication with other vehicles or cellular networks. The wireless system 402 may be provided by the vehicle 400 or may be a cell phone or other electronic device that is not a physical part of the vehicle 400.

Vehicle 400's camera 401 may produce image frames 405. Alternatively or in addition, image frames 405 may be processed image frames 61. Detected information 406 may be information 65.

Location information 407 may be information from a global positioning system or satellite navigation system relating to the current location of vehicle 400 or of a road sign associated with an image frame 405. Other known systems may be used to determine location information 407. The location information 407 may be provided to the vehicle through a cell phone or other mobile device.

A qualified vehicle list 404 may be maintained by computer 403. The qualified vehicle list 404 may list other vehicles and their capabilities to process or receive information, as explained in more detail below.

Other vehicles 420 may be similar to vehicle 400 in that they may have a camera 421, a wireless system 422, a computer 423, their own qualified vehicle lists 424, image frames 425, detected information 426, location information 427, and/or digital maps 428. However, the individual components and capabilities of other vehicles 420 may not the same as vehicle 400 or as other vehicles 420. Computer 423 may have a handshake module 423a, a prediction module 423b, a coordination module 423c, a preliminary sign detection module 423d, a panel extraction module 423e, a multi-frame processor module 423f, and a classification module 423g, as shown in FIG. 4C. An other vehicle 420 with only a handshake module 423a may only receive information 406. An other vehicle 420 with a preliminary sign detection module 423d and a panel extraction module 423e may process image frames 405. If an other vehicle 420 has all of the modules, its functionality may be identical to vehicle 400. To the extent that an other vehicle 420's computer 423 is capable of running modules but does not have the software to do so, vehicle 400 may be configured to permit other vehicles 420 to download the software via handshake module 403a.

Other vehicles 420 may be in data communication with vehicle 400. Multiple other vehicles 420 may be in data communication with vehicle 400 at the same time.

To begin data communication between a vehicle 400 and one of the other vehicles 420, a handshake 411 may first occur by a handshake module 403a on the computer 403. As part of the handshake 411, the other vehicle 420 may provide a list of its capabilities. For example, the other vehicle 420 may provide specifications of its processing power and capability to process image frames in accordance with the systems and methods disclosed in FIG. 1. Alternatively, the other vehicle 420 may not have a computer 423 so capable and may only be able to receive information 406, such as speed limit information, for display or use in the other vehicle 420.

The computer 403 may have a prediction module 403b for predicting whether the other vehicle 420 may stay within communication range until the completion of the computation based on the information. This prediction may be based on the strength of the received communications, or may be based on location, speed, or navigation information provided by the other vehicle 420 to vehicle 400.

If the computer 403 determines that other vehicle 420 may process image frames 405, it may update its qualified vehicle list 404 to identify other vehicle 420 as a qualified vehicle. If the vehicle 420 may only receive information 406, qualified vehicle list 404 may be updated to reference other vehicle 420 as a non-qualified vehicle.

The computer 403 may have a coordination module 403c for coordinating the processing of image frames 405. Coordination module 403c may distribute a subset of image frames 405 for processing by other vehicles 420. This allows for faster processing or allows for the consideration of additional frames in the calculation, leading to higher accuracy results.

Assuming results 413 are received by the computer 403, the computer 403 may combine the processed image frames 61 included in the results with the processed image frames 61 the computer 403's modules calculated and proceed with providing the processed image frames 61 to the muti-frame processing module 403f to generate an average image frame 63 for classification by classification model 403g. Classification model 403g outputs information 406, such as a calculated speed limit, and sends the information 406 to other vehicles 420.

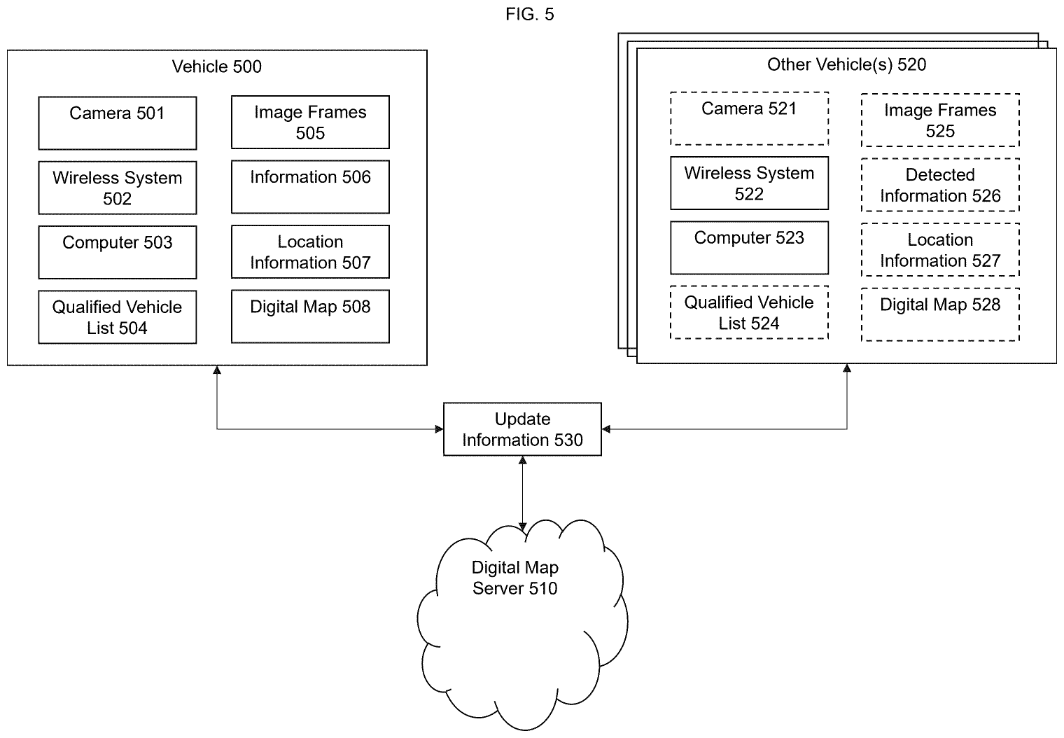

FIG. 5 shows a schematic diagram for utilizing the output of the systems and method for computer recognition of road signs of FIG. 1 using to update digital map servers. Vehicle 500 is similar to vehicle 400 and vehicle 2. Other vehicles 520 are similar to other vehicles 420.

A digital map server 510 is provided in data communication with at least vehicle 500 and potentially one or more vehicles 520. Upon determination of information 506, whether processed solely by the computer 503 or in collaboration with other computers 523, information 506 may be combined with location information 507 as update information 530. Update information 530 may also include image frames 505 (whether or not processed). The update information may be provided to a digital map server 510 for updating a digital map with the new information, such as a temporary speed limit. If the image frames 505 are included, the digital map server 530 may review or process such image frames 505 to ensure accuracy of the information provided. The digital map server 510 may then update a digital map based on the information 506 and the location information 507 in the update information 530. As would be understood, an other vehicle 520 may also provide update information 530 to the digital map server 510.

The digital map server 510 may distribute new digital map information to the vehicle 500 and/or other vehicles 520 as update information 530. Computers 503/523 may process the update information 530 with the new digital map information and update their respective digital maps 508/528.

If the vehicle 500 has a more up-to-date digital map 508 than an other vehicle 520, or vice-versa, they may generate or distribute update information 530 containing the new digital map information to the vehicle with the older digital map 508/528. This may be determined and distributed during the handshaking process 411 or may be trigged by the receipt of the new map information from the digital map server 510.

### Experimental Results

The above-described system was tested with digital speed limit signs that contain two lighted digits representing the current speed limit value. Each digit is composed of 70 LEDs, arranged in 5 columns by 7 rows for each digit. The digital speed limit sign functioned without noticeable flickering for the human driver. However, the speed limit displayed by LEDs is not captured completely by any camera in any of the frames.

The tested system used three different cameras to each produce a series of image frames. The cameras were:

TABLE I

| Camera model | Shutter type | Application | Settings |
|---|---|---|---|
| Stereolabs ZED 2 | rolling | stereo vision | factory default |
| | | | adaptive |
| Basler | global | machine vision | factory default |
| acA1300-200uc | | | manual |
| Logitech Brio 4K | rolling | webcam | factory default |
| | | | adaptive |

The data collection system used an Intel Core i7 10700K 3.8 GHZ, NVIDIA GeForce RTX 3070 8 GB, 32 GB DDR4-3200 RAM, Ubuntu 20.04, and ROS Noetic. The tests were conducted in sunny and overcast weather. The tests included digital speed limit signs showing 65 and 70 miles per hour and were on the left- and right-hand sides of the road. The vehicle was driven at 55 and 70 miles per hour. The later lane offset was 1 or 2. 6937 frames were captured.

All cameras were set to capture at most 30 Hz. The frame resolutions of the Basler camera, the Logitech camera, and the ZED camera are 1280×1024, 1920×1080, and 1920×1080, respectively. While the cameras capture at higher frequencies, the data acquisition system struggles to save captured frames to the local storage device in real time. Any frames that are not saved prior to a new frame being captured are discarded. Thus, the average observed capture rate is around 17 Hz. Test matrices include camera models, lateral position offset, speed limit values, vehicle speed, and digital speed limit sign locations with the weather as an environmental variable.

The three cameras were placed next to each other on the vehicle's roof, facing forward. Each combination of test matrices was collected 5 times. For each collection run, the data acquisition vehicle approaches the digital speed limit sign and continuously captures images until it passes the digital speed limit sign.

Data was reused by grouping it to mimic collecting frames at different capture rate tiers: low, medium, and high. As an example, if the system captured 17 frames in one collection pass, for a “high” capture rate all frames were grouped together. For a “medium” capture rate, every other 5 frames form a group such that five groups are obtained for each collection pass; or frames could be grouped at every other 4 frames if the effective capture rate is above 20 Hz and every other 3 frames otherwise. For a “low” capture rate case, every frame forms its own group, and 17 groups are obtained.

The results were compared to a known system that detects signs using only one frame, where a digital speed limit sign was considered detected if the speed limit in at least one frame in the group is detected correctly. For each capture rate tier, the detection rate is calculated by the number of detected groups over the total number of groups. For the known system, the overall detection rates are 25.23%, 61.70%, and 85.31% for low, medium, and high capture rates, respectively.

Results broken down by camera type for the known system at each data rate for each camera are shown in Table II. The known system results show that the digital speed limit sign detection challenge exists in all camera models evaluated, and that additional frames help in increasing accuracy.

Also shown in Table II are the results for the new system described herein. Since the new system relies on multiple frames, no results are shown for a “low” (1 frame) data rate. However, the new system significantly improves on the results of the known system and shows the same bias for higher frame rates.

TABLE III

| | Detection Rate[%] | | | | | |
|---|---|---|---|---|---|---|
| | Low | | Medium | | High | |
| | Known | New | Known | New | Known | New |
| Camera | System | System | System | System | System | System |
| Basler | 35.49 | N/A | 70.63 | 98.13 | 90.00 | 100.00 |
| Logitech | 37.10 | N/A | 85.47 | 98.13 | 98.75 | 100.00 |
| ZED 2 left | 13.48 | N/A | 50.38 | 97.19 | 76.25 | 98.75 |
| ZED 2 right | 14.87 | N/A | 49.23 | 99.17 | 76.25 | 98.75 |
| All Combined | 25.23 | N/A | 61.70 | 98.21 | 85.31 | 99.38 |

Camera type did not have a large impact on results, whether it was the Basler camera is designed for machine vision, ZED 2 is designed for stereo vision, or the generic Logitech Brio camera. The Basler and ZED 2 are more expensive than Logitech Brio. Regarding the frame capture rate, higher rates generally require more processing resources, which are usually limited, and these limited resources are shared by many systems, including perception, planning, decision making, control, etc. If speed limit or other road sign detection performs well while requiring a lower capture rate, some resources can be preserved for other safety-critical functionalities. The results show that the system described herein is computationally efficient as it achieves similar detection rates at the “medium” detection rate with fewer frames processed compared with the “high” detection rate.

The proposed method is designed to be part of a road infrastructure audit tool to address the challenge of LED flickering in DSL detection. As data collected in road au-dits can always be processed post-collection, we have not explored making it capable of running in real-time on a vehicle nor have we rigorously studied the computational time required for the algorithm.

While the present teachings have been described above in terms of specific embodiments, it is to be understood that they are not limited to these disclosed embodiments. Many modifications and other embodiments will come to mind to those skilled in the art to which this pertains, and which are intended to be and are covered by this disclosure.

As used herein, the term “about” indicates values generally within ±5%, as appropriate (e.g., a lower range limit is −5% and an upper range limit being +5%).

What it is claimed is:

1. A system for computer recognition of speed limit signs using a camera aboard a vehicle, comprising:
a camera capturing a plurality of image frames including a speed limit sign, the speed limit sign having light emitting diodes that flicker at a rate unequal to the capture rate of the camera;
a computer in data communication with said camera;
said computer having a sign detection module for identifying a region of interest from each of the image frames, said sign detection module having:
a deep neural network detection module for determining a bounding box of the region of interest, the deep neural network detection module trained on images of speed limit signs; and
an optical character recognition and processing module for determining whether the region of interest is a false positive;
said computer having a panel extraction module for extracting a portion of the region of interest with light emitting diodes from each of the image frames and outputting a plurality of processed image frames, said panel extraction module having:
a segment anything module, receiving the bounding box as input, for generating a binary mask relating to the digital speed limit sign in the image frame;
an edge detection module, receiving the binary mask as input, for detecting the edges of the digital speed limit sign in the image frame and outputting the detected edges;
an inverse perspective mapping module for projecting the region of the image frame within the detected edges onto an image plane to output a projected image frame;
a cropping module for cropping the projected image frame based on the binary mask to produce a cropped image frame;
an equalization and binarization module inputting the cropped image frame and setting each pixel in the cropped image to either be at a first value or a second value and outputting a processed image frame;
said computer having a multi-frame processing module receiving the plurality of processed image frames as input and for averaging the pixel values of each of the processed image frame, and outputting an average image frame; and
said computer having a deep neural network classification model for determining a speed limit displayed on the speed limit sign.

2. The system of claim 1, wherein the edges define a shape selected from at least: a circle, a triangle, a square, a quadrilateral, a hexagon, an octagon, a pentagon, a crossbuck, a crest, or a shield.

3. The system of claim 1, the computer further having a training module for training the classification model based on the determined speed limit.

4. The system of claim 3, the computer further having a testing module for evaluating the trained classification module.

5. The system of claim 1, wherein the speed limit is indicated in the vehicle.

6. The system of claim 1, wherein the speed limit is used in connection with the operation of the vehicle.

7. The system of claim 1, wherein the computer distributes execution of the panel extraction module for different image frames to other computers in other vehicles, and collects processed image frames from the other computers for execution of the multi-frame processing module and classification module on the computer.

8. The system of claim 1, wherein the speed limit and information regarding the location of the speed limit sign are sent to a digital map server for updating a digital map.

9. A system for computer recognition of road signs using a camera aboard a vehicle, comprising:
a camera capturing a plurality of image frames including a road sign;
a computer in data communication with said camera;
said computer having a sign detection module for identifying a region of interest from each of the image frames, said sign detection module having a detection module for determining a bounding box of the region of interest;
said computer having a panel extraction module for extracting a portion of the region of interest having light emitting diodes from each of the image frames and outputting a plurality of processed image frames, said panel extraction module having:
a segment anything module, receiving the bounding box as input, for generating a binary mask relating to the road sign in the image frame;
an edge detection module, receiving the binary mask as input, for detecting the edges of the road sign in the image frame and outputting the detected edges;
an inverse perspective mapping module for projecting the region of interest onto an image plane based on the detected edges to produce a projected image frame;
a cropping module for cropping the projected image frame based on the binary mask to produce a cropped image frame; and
an equalization module inputting the cropped image frame and setting at least a subset of the pixels to a first value and outputting a processed image frame;
said computer having a multi-frame processing module receiving the plurality of processed image frames as input and for averaging the pixel values of each of the processed image frames, and outputting an average image frame; and
said computer having a classification model for determining a quantum of information displayed on the road sign.

10. The system of claim 9, wherein the detection module is a deep neural network trained on images of road signs.

11. The system of claim 9, wherein the road sign is a speed limit sign and the quantum of information is a speed limit.

12. The system of claim 11, wherein the speed limit is indicated in the vehicle.

13. The system of claim 11, wherein the speed limit is used in connection with the operation of the vehicle.

14. The system of claim 9, wherein the quantum of information is transmitted to a database for recall.

15. The system of claim 9, wherein the edges define a shape selected from at least: a circle, a triangle, a square, a quadrilateral, a hexagon, an octagon, a pentagon, a crossbuck, a crest, or a shield.

16. The system of claim 9, wherein the classification model is a deep neural network, and wherein the computer further has a training module for training the classification model based on the determined quantum of information.

17. The system of claim 9, the computer further having a testing module for evaluating the trained classification module.

18. The system of claim 1, wherein the computer distributes execution of the panel extraction module for different image frames to other computers in other vehicles, and collects processed image frames from the other computers for execution of the multi-frame processing module and classification module on the computer.

19. The system of claim 1, wherein the speed limit and information regarding the location of the speed limit sign are sent to a digital map server for updating a digital map.

20. A method for computer recognition of road signs using a camera aboard a vehicle, comprising the steps of:
providing a camera capturing a plurality of image frames including a road sign;
providing a computer in data communication with said camera;
executing a sign detection module on said computer for identifying a region of interest from each of the image frames, including executing a detection module for determining a bounding box of the region of interest;
executing a panel extraction module for extracting a portion of the region of interest having light emitting diodes from each of the image frames and outputting a plurality of processed image frames, including:
executing a segment anything module by receiving the bounding box as input and generating a binary mask relating to the road sign in the image frame;
executing an edge detection module by receiving the binary mask as input and detecting the edges of the road sign in the image frame and outputting the detected edges;
executing an inverse perspective mapping module for projecting the region of interest onto an image plane based on the edges to produce a projected image frame;
executing a cropping module for cropping the projected image frame based on the binary mask to produce a cropped image frame;
executing an equalization module inputting the cropped image frame and setting at least a subset of the pixels to a first value and outputting a processed image frame;
executing a multi-frame processing module on said computer by receiving the plurality of processed image frames as input and averaging the pixel values of each of the processed image frames, and outputting an average image frame; and
executing a classification model for determining a quantum of information displayed on the road sign.

21. The method of claim 16, wherein the road sign is a digital speed limit sign having light emitting diodes that flicker at a rate unequal to the capture rate of the camera, and further comprising:
the step of executing the sign detection module further comprising the step of executing an optical character recognition and processing module for determining whether the region of interest is a false positive, and wherein the detection module is a deep neural network detection module trained on images of speed limit signs;
and wherein the quantum of information is a speed limit displayed on the digital speed limit sign.
